(19) United States
(12) Patent Application Publication
(10) Pub. No.: US 2005/0240418 A1
(43) Pub. Date: Oct. 27, 2005

(54) Identification of a user of a mobile terminal and generation of an action authorisation

(76) Inventor: Pierre Chappuis, Gumligen (CH)

Correspondence Address: H T Than Law Group;Waterfront Center, 1010 Wisconsin Avenue N W, Suite 560, Washington, DC, 20007, US

(21) Appl. No.: 10/523,583

(22) PCT Filed: Oct. 11, 2002
(86) PCT No.: PCT/EP02/11420

§ 371 Date: Jun. 23, 2005

(51) Int. Cl. G06F 17/60

(52) U.S. Cl. 705/1

(57) ABSTRACT

A method is proposed with which a user (1) of a mobile terminal (11), in particular of a mobile telephone or a PDA, can be identified and an authorization for an action can be issued to this user (1). An independent identification module (2) serves this purpose. First, a request is sent by the user (1) for an identification/authorization via an air interface, for example an SMS message, to the identification module (2). An action code (TRX) is created in this module, which has one-off validity and, in addition, is only valid for a limited time. This TRX is sent from the identification module both to the user (1) of the mobile terminal as well as to a terminal (3) of a third party participating in the action. Examples of the third party (3) are: a supermarket, access lock system, bank, or election authority. The performance of the desired action, such as payment, access through a lock system, e-banking or the casting of a vote in an election, can be initialized by the terminal (3) of the third party. For the termination (20), the user (1) inputs a PIN into the terminal (3) of the third party, or sends the PIN directly or via the identification module (2) to the terminal (3) of the third party.

The present invention relates to a method for the identification of a user of a mobile terminal and the generation of an action authorization for the user. The mobile terminal in this situation can in particular be a mobile telephone, a Personal Digital Assistant (PDA) or the like. The actions in question are in general procedures that require an authorization, such as, for example, payment procedures, person-specific passing of doors or barriers, or the casting of votes in an election. The invention also relates to use of the method according to the invention, to a system for the performance of the method according to the invention, and to a software program by means of which implementation of the method according to the invention is possible.

Most security systems in connection with credit cards, payment cards, electronic banking, or access controls to areas or even computer networks, are based on static data, such as, for example, credit card numbers, data on magnetic strips or chips, photos, numbers on a checklist in printed form, badges or tokens. The risks associated with this, such as in the event of fraudulent use of a credit card, are evident and generally known.

Security systems that are based on dynamic data are used, for example, for access controls, network notifications to a personal computer, or for e-banking. Preferably, processors are used for this that generate dynamic values for code numbers at regular intervals of time by means of special algorithms. These are then compared, in the case of a notification or access or the like, with reference values, and, if there is a match, clearance is initiated.

In addition to these known “SecurID components”, such as are marketed, for example, by “RSA Security”, there have recently become available increasing numbers of PDA's, Organizers, and the like, as well as mobile telephones which are in a position to carry out functions of this kind.

One insecure component in this connection, with the prior art, is the fact that security-relevant data, such as the number of a credit card, must be sent to a party involved with the action, such as the operator of a supermarket. For example, security-relevant data from a credit card is acquired by a reader device at a payment terminal in order to initialize a transaction. In this situation the security-relevant data is transferred, checked, cleared, and the payment transaction terminated. The data items on the credit card used are static. They are shown on the voucher that is presented for signature more or less unprotected.

A number of companies have gone over to leaving out the last four digits in the printout on the voucher. Nevertheless, the risk of misuse cannot be excluded, inasmuch as the card is temporarily made accessible to the other party to the contract.

The object of the present invention is based on providing a technology which enables a user of a mobile terminal, in particular a mobile telephone, to be identified and for an authorization to be generated for him to carry out an action, whereby with simple handling a particularly high level of security can be guaranteed.

This object is achieved according to the invention by the features of the independent claims. The dependent claims extend the central concept of the invention in a particularly advantageous manner.

According to the invention, a user of a mobile terminal, in particular of a mobile telephone, PDA, or the like, is first identified. An authorization is then produced for him to carry out an action, and passed to him as well as to the other parties involved.

In this situation, in a first step, the user of the mobile terminal sends a request from the mobile terminal, via an air interface, such as by means of a “Short Message Service” (SMS), a request for an action authorization to an identification module. The identification module in this situation is independent of the user or operators respectively.

Together with the request, an identification code is sent by the mobile terminal to the identification server. As a result of the data sent it is possible for the user to be identified by the identification module.

In a following step, an action code is produced by the identification module, and this is sent to the mobile terminal. The action code represents for the user of the mobile terminal an authorization for the performance of an action.

The method is characterized in that the action code has a time-limited validity. The duration of the time limit can in this situation be selected in accordance with the special request that is indicated by the action concerned.

It is further advantageous if the action code has one single validity. Multiple validity of the action code is also possible, whereby, however, it is advantageous for the maximum number of action authorizations per action code to be limited. This achieves a particularly high degree of security in the issue of an action authorization.

By the use of an action code that is only valid once, together with a temporal limitation of the validity of the action code, a particularly high degree of security is achieved. The possibility of decoding does indeed in principle pertain, but with suitably selected time limitation the risk of decoding within this specified period of time can be as good as excluded. Just as unlikely is the allocation of such an action code, since the application relating to the respective involved parties is not known.

Security is further enhanced by the fact that the user of the mobile terminal additionally sends a personal identification number (PIN) together with the request, and this is jointly taken into account by the identification module in the identification of the user.

In addition to this, security can also be enhanced by the fact that the communication between the mobile terminal and the identification server is carried out, at least partially, in encoded form.

It is further advantageous if the communication between the mobile terminal and the identification module is carried out at least partially by means of a data channel, such as, for example, by means of an SMS message of the GSM Standard. As a result of this, no service channels are occupied. This is also favorable because of the wide distribution of the SMS service. In the final analysis, a data channel of this kind is also more secure against interference than a service or speech channel.

It is also advantageous if data is used for the communication between the mobile terminal and the identification module which is read out from a data carrier or memory, for example in the form of a “Subscriber Identity Module” (SIM) card in the mobile terminal.

In particular, as a further security measure in the transmission from the mobile terminal to the identification module, network information can also be transmitted. For example, the possibility pertains of information relating to the provider concerned and/or the mobile radio cell being used can also be sent.

If, for example, a payment to a payment terminal is requested by the user, the identification module can carry out a check, for the sake of security, as to whether the payment terminal concerned is located in the area of that mobile radio cell from which the request from the user was sent.

With regard to the reception of the action code by the mobile terminal, it may be advantageous if the action code is shown on the display of the mobile terminal, but not stored on a data carrier, such as on a SIM card of the mobile terminal. As a result of this, later fraudulent reading of the action code is excluded.

It may, however, also engender advantages if specific data of a different kind that relates to the action is stored on a data carrier of the mobile terminal. This then makes it possible for the data to be available later, ready to be called up, and, for example, for it also to be transferred to another device, such as a PC. This data may relate to the amount of a payment, for example, or, in the case of a cash withdrawal from an automatic cash dispenser, the amount withdrawn, the identification number of the cash machine used, or the time of the cash withdrawal.

In addition, with the method according to the invention, it is possible for the action code to be sent, as well as from the identification module to the mobile terminal, also to a terminal at a third location or a third party. Advantageously in this situation, an identification number known to the user is additionally sent.

The third party is in this situation involved in the action concerned. In the case of a payment procedure, for example, this may involve a payment recipient.

A specific example of a third-party terminal is a payment terminal in a supermarket. A further example is a terminal of a municipality which is carrying out “electronic voting”, known as e-voting for short. In the latter example, the terminal could be provided in the form of a server in the municipal computer center.

It is particularly advantageous if the communication between the identification module and the terminal is likewise carried out via an air interface. As a result of this it is possible for a terminal to be used for the method according to the invention even with the availability of fixed communications lines at the location of the terminal.

With this communication, an encoding for enhancing security can also be advantageous.

In particular, the possibility pertains of the communication being transferred via a data channel. It is, for example, a simple matter nowadays for GSM-compatible payment terminals to be produced which can be actuated on the server side.

Formulated in general terms it is advantageous, according to the method according to the invention, if procedures can be initiated by means of the terminal of the third party which are necessary for the performance of the action concerned.

As mentioned earlier, the terminal may for example be a payment terminal. If the action concerned is a payment action, this is necessary for the performance of the action, i.e. the payment.

A further example of a third-party terminal is a GSM-compatible terminal that is connected to a lockable door, so that the door can be opened via the terminal.

A further advantage is also a GSM-compatible terminal of an entrance ticket or travel ticket sales point, whereby the printing of such tickets can be initiated by the terminal. Termination can be carried out by the identification number referred to earlier being input by the user directly at the terminal of the third party. Because the identification number valid for the action is present in the terminal, the input can then be checked and, if they match, the action can then be terminated.

According to the method according to the invention, as an alternative in a further step, a message can be sent by the mobile terminal to the identification module that contains, for example, an identification number. The procedure can be designed in such a way that the action is terminated by the sending of this message.

Termination is carried out in this case by the terminal of the third party being actuated accordingly by the identification module.

As a further alternative, termination can be carried out by a message being sent directly to the terminal by the mobile terminal. This message in turn contains, for example, the identification number sent previously to the terminal from the identification module. This significantly enhances security still further.

Communication between the mobile terminal and the terminal can of course also be carried out via an air interface in encoded form and via a data channel.

For a further area of use of the method according to the invention, it may be advantageous if, as an alternative to the last step referred to, the action code can be used in another manner by the user of the mobile terminal.

It is possible, in particular, for provision to be made for the use of the action code as a “password”. For example, the method can be designed in such a way that the user obtains access via the Internet to non-public Web pages by inputting the action code into a PC.

Such a password can also be provided, for example, as access control to networks, such as computer networks. The action code in this situation can serve directly or indirectly as a password. In this way a “virtual access control” can be realized.

The casting of votes in the case of an e-voting procedure can also be achieved, for example, via the Internet onto a server of a voting organizer.

The method is particularly well-suited to the performance of payment procedures. Formulated in general terms, the terminal functions in this case as a “payment terminal”. The action code is in this case in particular more pertinently designated as a “transaction code”.

The method according to the invention can, however, also be used for transactions for which no payment terminals are necessary, for example for uploading a “prepaid card”.

Naturally, the data of the participating financial institution which is of relevance to the payment in question must be available in the identification module, for example in the form of a credit card number with expiry date and the credit limit of the user assigned to the card.

This can be achieved, for example, if the identification module is connected to a corresponding database of the financial institution concerned.

In this case, for example, the user of the mobile terminal can send, together with the request for the payment procedure, the number of the credit card used (or other suitable card) and the expiry date.

In particular, it may be advantageous in this situation for the user to send a maximum amount for the payment procedure being requested, as a “payment framework”. This payment framework then serves as an upper limit for the actual amount of the payment transaction.

In addition to this, an identification number for the payment terminal at which it is intended that the payment should be made can also be sent. Advantageous in this case, with the use of the method according to the invention on several payment terminals, is the unambiguous allocation in each case of an identification number to one payment terminal.

As a further security measure, it may be required that the request by the user must be confirmed by the sending of a personal identification number to the identification module.

In the identification module, the data elements transmitted are checked after receipt of the request, taking into consideration the data provided by the financial institution concerned.

In particular, in this case, a payment framework that may have been sent can be checked for validity.

If the data received concurs sufficiently and is of sufficient plausibility, the transaction code is then generated by the identification module. Advantageously this is only valid once, and, in addition, is only valid for a limited period of time.

Following this, the transaction code is sent to the mobile terminal by the identification module on the one hand, and sent to the payment terminal on the other. The possibility is of course provided in this step of also sending data relating to the time validity.

In particular, if appropriate, the payment framework can also he sent by the identification module to the payment terminal.

An identification number is additionally sent to the payment terminal, which is known to the user of the mobile terminal.

To terminate the payment procedure, the identification number sent by the user to the payment terminal is then passed to the payment terminal, for example together with the payment amount.

This can be done, for example, by direct input of the identification number by the user into the payment terminal via a keypad.

As an alternative it is also possible to send the identification number to the payment terminal, for example by means of the mobile terminal.

The use of the notification of a payment framework offers the decisive advantage that the actual payment procedure can in principle be carried out substantially faster than in the prior art: Checking of the payment framework, which necessarily takes a certain amount of time, can be carried out before termination, as a preliminary authorization; i.e. before the actual payment process itself. If the payment framework is valid, the actual payment then takes place simply and rapidly by the user inputting the identification number.

It is possible, for example, for the payment framework to be checked at a payment terminal, at which a queue has already formed, while the user is waiting in the queue.

It is also worth mentioning that in this way the recipient of the payment is not provided with any sensitive data, such as the credit card number or the card expiry date. The recipient of the payment only receives the transaction code and the identification number.

This transaction code can also appear on a printed payment voucher, possibly requiring a signature. In any event, as a consequence it is no longer capable of being misused. Misuse by the recipient of the payment is therefore excluded, in comparison with the method currently in use.

Further features, advantages, and properties are now explained on the basis of a detailed description of embodiments and by reference to the Figures of the appended drawings. These show:

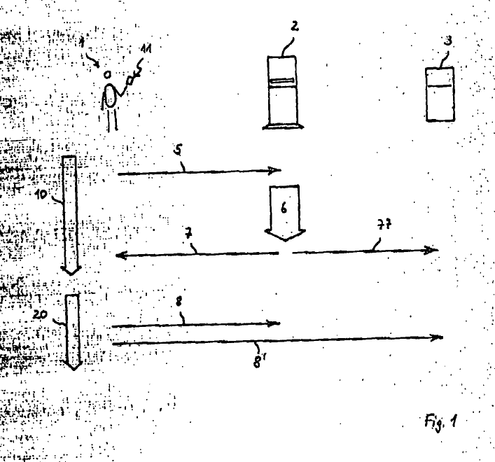

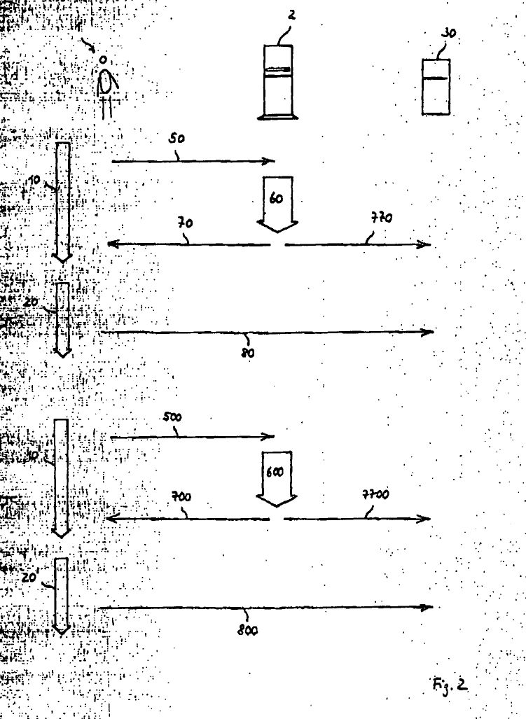

FIG. 1 Basic sequence diagram of the method according to the invention;

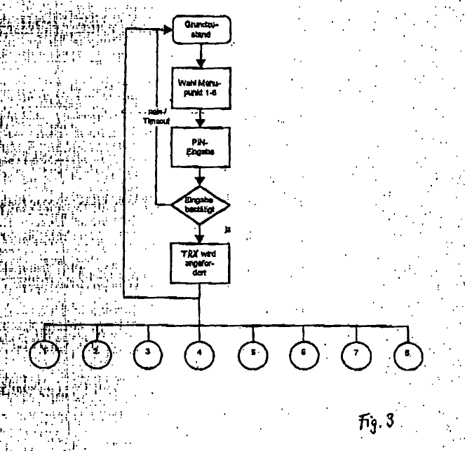

FIG. 2 Sequence diagram of the method according to the invention in the case of application within the framework of a voting procedure during an election or referendum;

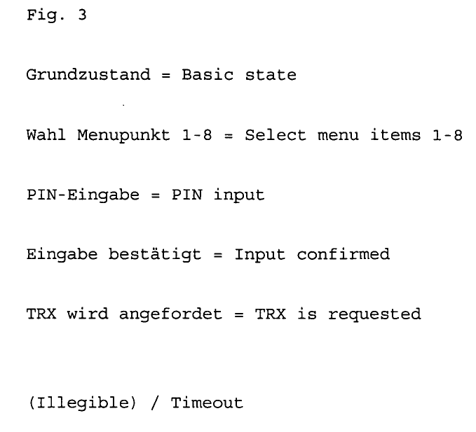

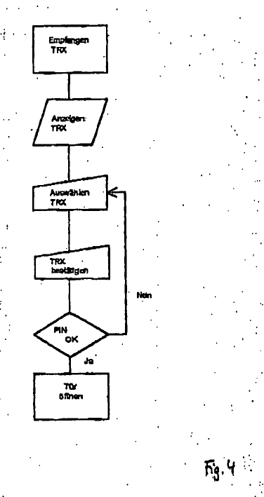

FIG. 3 Data flowchart—Basic module;

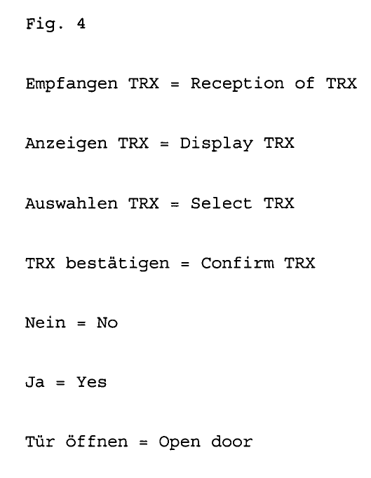

FIG. 4 Data flowchart—Opening an access lock;

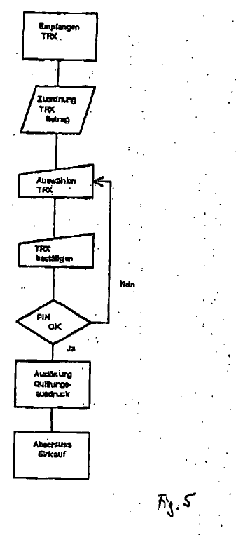

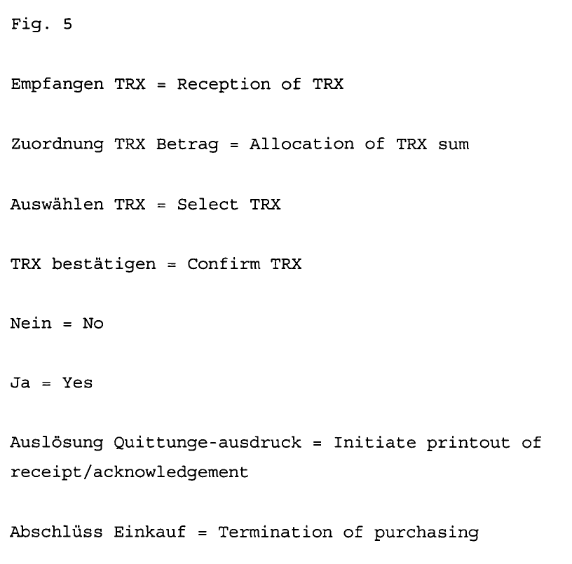

FIG. 5 Data flowchart—Payment with credit or debit card;

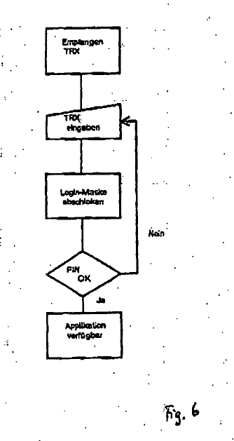

FIG. 6 Data flowchart—Transfer of an e-banking checklist code;

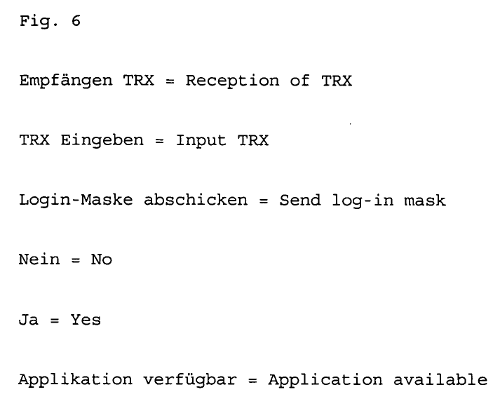

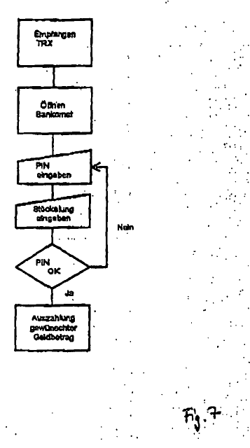

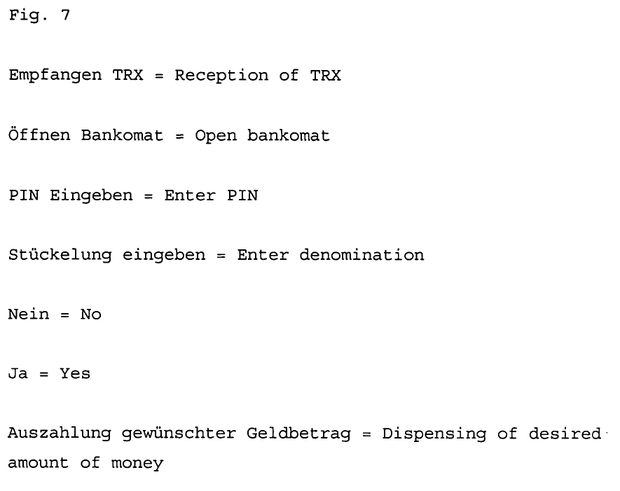

FIG. 7 Data flowchart—Cash withdrawal from an automatic cash dispenser;

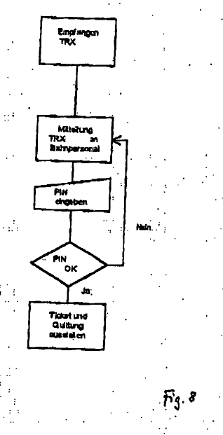

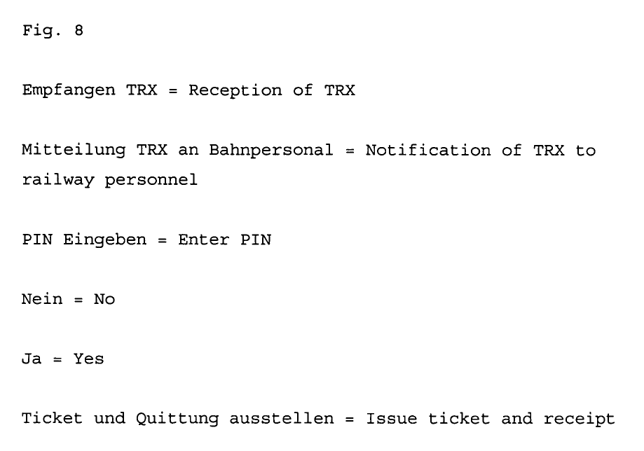

FIG. 8 Data flowchart—Production of a ticket in an e-ticketing system; and

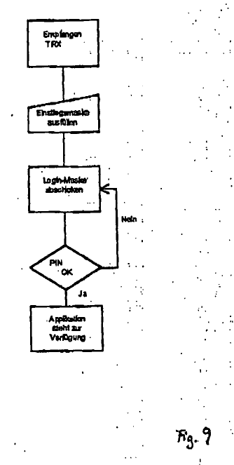

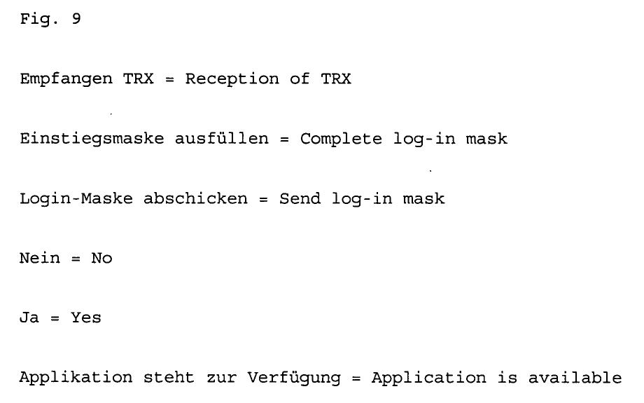

FIG. 9 Data flowchart—Transfer of an access password.

The use of the reference numbers hereinafter is continuous.

FIG. 1 shows in diagrammatic form the temporal sequence of the method according to the invention. In this situation, this involves a user 1 of a mobile terminal, in this case in the form of a mobile telephone 11, an identification module 2, and, as a rule, a terminal 3 of a third location or a third party respectively.

Considered overall, the method can, as a rule, be subdivided into two sections: A “pre-authorization” phase 10 and a “termination” phase 20.

Pre-Authorization

With pre-authorization 10, in a first step 5 the user 1 of the mobile telephone 11 requests an action code from the identification module 2 by means of menu control. For the sake of simplicity this is designated hereinafter by TRX, derived from the word “transaction code”.

Together with this request, in general, further action-specific data is also transferred.

Notification can be given, for example, as to which action the TRX is intended to relate. Examples of these actions are:
Allowing the user 1 to pass through a controlled door or barrier,
Payment procedure with a credit card or debit card,
Obtaining of a TRX as a checklist code for e-banking,
Cash withdrawal by the user 1 from an automatic cash dispenser,
Purchase of an “electronic ticket” by remote transaction,
Access by the user 1 to a non-public page of the World Wide Web on the Internet,
Participation by the user 1 in an “e-voting” procedure.

In addition to this, the request message can contain data that relates to a terminal 3 which may be involved in the action. For example, this may involve the identification number of a payment terminal in a supermarket or the identification number of an automatic cash dispenser or the identification number of a payment terminal for the “e-ticketing” process.

Depending on the action, in step 5 further action-relevant data is also transferred, such as, for example, details of the SIM card used, such as in the form of the “Integrated Circuit Card Identifier” (ICCID), a PIN number for the user, details of the mobile radio cell used—“Cell Identification” (Cell ID), details of a payment framework, etc.

The request 5 is carried out, for example, by means of the SMS service via a telecommunications network of a mobile radio network operator in accordance with the GSM Standard. The message, via SMS Center, is transferred to the identification module 2 by wireless means by the network provider concerned.

Particular security is achieved in this situation if the transmission is carried out at least partially encoded. This can be carried out, for example, by the use of “Triple Data Encryption Standard” (3DES).

In a second step 6, the request from the user 1 is registered in the identification module 2, and the data transmitted in the request 5 is checked.

For this purpose, for example in the case of a payment procedure, data relating to the financial institution concerned and relevant to the payment concerned is held available in the identification module. This might be, for example, a credit card number of the user 1, with the expiry date of the credit card, or a corresponding credit framework available.

In this respect it is also possible, for example, for the identification module to carry out a comparison between the location of the payment terminal concerned and the area of the mobile radio cell from which the request was made.

If the data transferred is valid, a once-valid TRX is then generated by the identification module 2, or more precisely by a server of the identification module 2, which is provided with a time restriction. The time restriction can in this case be set entirely at will. For example, in the case of a payment procedure at a supermarket checkout, the time limitation can be set at 15 minutes. The duration of the time limitation is selected for the purpose as a function of the action concerned.

The duration of the time restriction in this situation is directly related to security, since in principle the possibility of decoding for misuse increases with the duration of validity. Accordingly, the duration of validity should for the sake of security be reduced to an adequate minimum.

In this way it is possible for misuse in this respect to be practically excluded. It is to be expected that, as a result, the general acceptance of non-cash payment transactions can be significantly increased.

In a further step 7, the TRX that is generated in this way is then transferred to the user 1 of the mobile telephone 11.

With the sending of the TRX to the user 1, the “core element” of the invention is concluded, since the TRX represents an action authorization for the user 1. As an example of this, a TRX used as a checklist code may be cited.

For most of the examples represented here, however, other steps are advantageous and are therefore described in greater detail hereinafter.

With most of the applications described here, the TRX is additionally sent 77, for example by means of an SMS message, to a terminal 3 of a third party involved in the action.

This third party can be, for example:
A terminal 3, which is connected to an access lock system,
A payment terminal 3 for credit and debit cards,
A terminal 3 of a financial institution, which is connected to an automatic cash dispenser for a cash withdrawal,
A terminal 3 at a stationary or mobile ticket sales location for “electronic ticketing” as a remote transaction,
An Internet server 3,
A server 3 of a public authority, which is carrying out an “e-voting” procedure.

In FIG. 1 a terminal 3 is shown in diagrammatic form to represent a third party.

The transmission to the terminal 3 of the third party can in turn be carried out via an air interface. For example, a payment terminal 3 of the third party can be actuated via a GSM module.

During the transmission 77 it is in turn also possible to increase security still further by encoding the message sent.

As an additional security measure, in step 77 an identification number can be sent, for example in the form of an “Applications PIN”, by means of which the provenance of the TRX from the identification module 2 is confirmed. This Applications PIN is known to the user 1. Further details of this are provided hereinafter.

The pre-authorization procedure is thereby concluded.

Termination

Termination can be carried out in different ways, (i), (ii), (iii):

(i) If the Applications PIN concerned is present at the terminal 3, the possibility pertains of the Applications PIN concerned to be input by the user 1 for termination 20 directly at the third-party terminal 3, for example by way of a keypad.

(ii) As an alternative, for termination 20 the user 1 of the mobile telephone 11 sends 8 a message to the identification module 2. This may be, for example, the Applications PIN concerned. It is also possible, however, for another message to be used, specially agreed between the user 1 of the mobile telephone 11 and the operator of the identification module 2.

The message that is received is thereupon checked for correctness and validity in the identification module 2.

If it is valid, the action authorization is then activated by the identification module 2 by means of message transfer to the terminal 3 of the third party, and the action requested by the user 1 by means of the mobile telephone 11 can then be carried out.

The transfer of the message from the identification module 2 to the further party 3 can in this case be carried out in turn via an air interface. For example, the terminal 3 of the third party can be actuated by the identification module 2 via a GSM module.

With this message, the procedure is terminated on the part of the mobile telephone 11, and the action authorization is thereby activated.

(iii) In the final analysis, it is also possible, for the purpose of termination, for the user 1 of the mobile telephone 11 to send a message 8′ directly to the terminal 3 of the third party. This message contains in turn, in addition to the TRX, a further message, for example again in the form of the “Applications PIN”, which is especially agreed for this purpose between the user 1 of the mobile telephone 11 and the third party 3, such as an “applications operator”.

In particular, the procedure can be designed in such a way that the “Applications PIN”, as indicated above, is sent 77 at pre-authorization 10 by the identification module 2, together with the TRX, to the terminal 3 of the third party, and is therefore present at the terminal 3.

By means of the termination 20, the following procedures can be actuated, for example:
An access door opens,
A payment procedure with a credit card or debit card is carried out,
An automatic cash dispenser issues cash,
An “electronic ticket” is produced and issued,
“Virtual access” to a network is enabled.

The transfer of the message 8′ does not have to be carried out exclusively by means of the mobile telephone 11. It can, for example, as an alternative, be sent by a PC belonging to the user 1 via the Internet to a server, which functions as a terminal 3 of an applications operator. This may, for example, be a message in accordance with the “File Transfer Protocol” (FTP).

The message 8′ can also be used as a password indicator. In this way, for example, access to networks, such as to an intranet, can be regulated or monitored respectively.

In any event, with termination 20 by the user 1, the action authorization is activated and the procedure desired or requested by the user 1 can be carried out.

For example, an applications operator can be the public authority of a municipality, which is carrying out an e-voting procedure. In this case, with the termination 20, the user 1 can send his vote for the e-voting to the municipality by means of FTP via the Internet, together with the corresponding Applications PIN agreed between the user 1 and the municipality.

A further example of an applications operator is a bank. For example, the user 1 (in step 5) can request from the bank access to secure Web pages for e-banking. In step 8′, the user 1 then sends from his PC, together with the TRX, the “Applications PIN” agreed between the user 1 and the bank, via the Internet, to the bank server. The “Applications PIN” in this case therefore has a “password function”.

A particular advantage with the method in question is that no security-relevant data relating to the user 1 need be sent to the other party. It is therefore not necessary, for example, for the credit card number used for the transaction to be sent to the payment recipient.

The situation is also possible in which the operator of the identification module 2 and the third party 3 are identical. In this case, the transmission of the TRX represented by step 77 from the identification module 2 to the third party 3 is evidently superfluous.

In general, however, the identification module 2 is independent of the third party.

The use of the method according to the invention is represented hereinafter on the basis of FIG. 2, using the example of an “e-voting” procedure.

If a referendum or election is carried out with the aid of the method according to the invention, in a first step “download of voting documents” takes place, and then, in a second step, the actual voting. Both in Part One as well as in Part Two, the method according to the invention is run through separately in each case. In this situation, each of the two parts is subdivided into a pre-authorization part 10 or 10′ respectively, and a termination part 20 or 20′ respectively.

For preparation, in the first instance, for example, the public authority concerned in a municipality sends a letter to a user 1 who is entitled to vote. This letter contains instructions regarding the initialization of the mobile telephone 11 for the e-voting function and personal access information, as well as access instructions.

In a further step, voting documents and relevant information material is prepared by the public authority. Registered e-voters do not require any documentation in letter form in this situation.

In step 50 of the first part, the user 1 now requests, by means of an SMS message to the identification module 2, a TRX for the “e-voting download”. This message is confirmed by the user 1 by sending an Applications PIN.

In a next step 60, the request that has been received is then processed in the server of the identification module 2 by verification and checking of the authorization for access, and, if it is valid, then a one-off valid TRX for the e-voting download is generated. This TRX in this situation is provided with a time restriction.

In the following step 70, this TRX is sent together with the corresponding time limit for the validity of the TRX by SMS message from the identification module 2 both to the user 1 as well as, in step 770, to the terminal 30 of the public authority. The public authority has for this purpose a server 30, which serves as a terminal, which is equipped with a GSM module and is additionally connected to the Internet.

In the next step 80, the user 1 can download the voting material from the server 30 of the public authority onto his PC, by means of PC and The Internet, after inputting the TRX and an Applications PIN. This Applications PIN can be sent beforehand, for example in step 770, to the server 30 of the public authority.

The first part is thereby ended.

In the second part, the user 1 initially requests 500 the identification module 2 by SMS message, within the framework of the pre-authorization 10′, to provide a further TRX for casting his vote. This request 500 is in turn confirmed by PIN (either the same PIN as in the first part or another PIN).

In step 600, the request 500 is processed by the identification module 2 by verification and checking of the authorization. If it is valid, a TRX is generated for the casting of the vote. This TRX is in turn only valid for a specific period of time and for one occasion only.

In step 700, the TRX for the casting of the vote is sent to the user 1 and, simultaneously in step 7700, to the server 30 of the public authority. In addition, in step 7700, a further corresponding Applications PIN, which in turn is known to the user 1, is sent from the identification module to the server 30 of the public authority.

For the termination 20′ of the second part, in step 800 the user 1 sends the TRX for casting the vote, together with the relevant further Applications PIN, by PC and the Internet, for example by FTP, to the server 30 of the public authority.

In this situation, the actual casting of the user's vote takes place within the framework of step 800.

This in principle concludes the second part.

In the final analysis, it is possible for a confirmation of receipt of the vote to be sent to the user 1 from the server 30 of the public authority by means of an SMS message. At the same time, the public authority can also impose a block on the user 1 casting a vote, either in person and/or by letter.

The assessment of the votes from e-voters can be carried out at the public authority 30 by means of a computer.

Thanks to the locationally-independent possibilities of arranging the vote according to the invention, and its particular flexibility with regard to time, an increase in participation in elections and referenda can be expected.

FIGS. 3 to 11 show data flowcharts according to the invention for sequences from the point of view of the user 1 of a mobile telephone 11. In this embodiment, the method is applied on several modules, which relate in each case to different types of actions.

FIG. 3 shows the basic module. In a basic state, in this situation one of eight selection modules is selected by means of menu control. In this context, each module represents a special type of action. The modules and corresponding types of action are shown in the following table assigned to one another:

| Module | |
|---|---|
| number | Type of action |
| 1 | Opening an access lock |
| 2 | Payment with credit card |
| 3 | Payment with debit card |
| 4 | Transmission of an e-banking checklist code |
| 5 | Cash withdrawal at automatic cash dispensers |
| 6 | Production of a ticket in the e-ticketing |
| | process |
| 7 | Transmission of an access password |
| 8 | E-voting |

The input of the selected module is confirmed with a PIN by the user 1.

Naturally, the mobile telephone 11 of the user 1 must be appropriately programmed beforehand. This is possible with the SIM cards that are available nowadays.

For example, the menu of the mobile telephone 11 can be arranged for this purpose in such a way that a menu item “Configuration” with a sub-menu item “New Service” can be dialed up. By means of this, the different modules can then be assigned by the user 1 to different action types, such as those referred to in the table above.

As a short addition, taking the “checklist code” as an example, an explanation will be given below as to how an appropriate arrangement of the mobile telephone 11 could in principle be set up. This is only considered briefly, since this does not relate to the core of the present invention. For the person skilled in the art in this sector, the appropriate programming of the SIM card is prior art. However, because the appropriate programming is directly associated with the invention, the sequence of the arrangement is presented below in the form of an overview from the point of view of the user 1.

First, the user 1 establishes a connection with the bank concerned by means of PC and The Internet. The Configuration program part on the corresponding Web page of the bank is selected and the contract number (with six to ten digits), a password (minimum of four digits), and possibly other appropriate data are input. Once the data has been sent, it is checked in the bank server and, if found valid, a one-off valid clearance code is generated. This is sent by post to the user 1, together with an initialization password.

The user 1 then selects the menu item “Configuration” and then “New Service” with the mobile telephone 11. The mobile terminal 11 then requests the clearance code, which the user 1 then inputs and which is then sent to the identification module.

Sending takes place in coded form, for example by means of 3DES, and contains the SIM card number, for example in the form of the twenty-digit ICCID, as well as the details of the provider concerned and the mobile radio cell used (Cell ID), in the form of network information.

The clearance code obtained is then checked by the identification module 2 and, if found valid, the first part of the “Checklist” program module is sent to the mobile telephone 11.

The mobile telephone 11 then issues a request for the input of the initialization password. This is input by the user 1, and the new menu item “Checklist” is then generated.

Once the “Checklist” menu item has been selected, the name of the bank concerned is displayed. This is confirmed by the user by pressing the “OK” key.

The mobile telephone 11 then requests the input of a password. Once this password has been input by the user 1, this is in turn sent to the identification module 2.

The identification module 2 checks the latter password, and, if found valid, the second and last part of the “Checklist” program module is sent to the mobile telephone 11.

This concludes the setting up of the new “Checklist” module. Following this digression, reference is now made to FIG. 3 again.

Taking the basic state as a starting point, the user 1 accordingly selects the desired module (or the desired type of action respectively) by means of menu control on his mobile telephone 11.

Depending on the module, as a rule additional information is required, such as, for example, the identification number of an automatic cash dispenser, the identification number of a payment terminal of the supermarket, or the like. Such information is of course also possible as an alternative in a step that follows later.

After a PIN has been input, the user confirms the input and sends it to the identification module 2. This transmission causes a TRX to be requested; this accordingly corresponds to step 5 from FIG. 1.

The inputs are checked by the identification module 2, and, if found valid, a one-off valid TRX with time-limited validity is generated. This TRX is sent both to the mobile telephone 11 of the user 1 and also, as a rule, to the terminal 3 of the third party concerned.

If the user 1 makes an incorrect entry or the time is exceeded during the input, the mobile telephone switches back automatically to the basic state.

A maximum number of possible input attempts can of course be set.

FIG. 4 shows the further sequence in the case of an access lock arrangement after the selection of module Number One.

After the TRX has been received by means of SMS message, it is displayed to the user 1 on the screen of the mobile telephone 11. The TRX is likewise provided at the door concerned.

The user 1 selects the TRX received by means of the menu on his mobile telephone 11, and confirms it by inputting the relevant Applications PIN.

This is then, again by SMS message, sent to the identification module 2. There the data is checked and, if found valid, a message is sent by the identification module 2 via a GSM interface to a terminal 3, which is connected to the door, which in turn activates the opening of the door.

If incorrect data is input by the user, the mobile telephone automatically switches back to the state in which the TRX can be selected.

As an alternative, the Applications PIN can be sent by the identification module 2 to the terminal 3. In this case, termination 20 can be carried out by the user 1 sending the Applications PIN directly to the terminal 3, and the opening of the door is actuated as a result.

It is also possible that in this case, for termination, the user 1 inputs the corresponding Applications PIN directly into the terminal, for example by means of a keypad.

FIG. 5 shows the sequence in the event of payment with credit card or debit card.

In this case, the code number of the relevant payment terminal 3 must be transferred to the identification module 2. The user 1 can, for example, issue this together with the request 5.

The possibility also pertains that the user 1 indicates, together with the request 5, a maximum sum as a payment framework, and this is likewise checked by the identification module 2, with the aid of corresponding details relating to the financial institution concerned.

An advantage of the method according to the invention which is particularly worth mentioning in this case is provided by the fact that the check on the payment framework takes place during pre-authorization and therefore separately from the actual payment process, i.e. the termination. By dividing the payment process into two parts in this way, it becomes possible for a payment to be prepared initially by the user 1 and for the actual payment to require substantially less time than is at present usual.

For example, the user 1 can prepare the payment for pre-authorization while waiting in a queue or the like. The setting up of the payment process can therefore be begun before the user 1 reaches the payment terminal 3.

After the TRX has been generated by the identification module 2, the TRX is sent to the user 1 and also to the payment terminal 3. The payment framework is likewise sent to the payment terminal 3, after validity has been checked. At the payment terminal 3 the price of the products purchased is then displayed as a payment amount, or the totaled price of the products purchased respectively. At the payment terminal 3, as mentioned, the payment framework is already immediately available.

The TRX is then selected by the checkout staff and the payment amount allocated to the TRX.

For termination 20, the payment amount is then approved by the user 1, together with the TRX and an Applications PIN.

After the validity of the transaction approval and of the Applications PIN that have been input has been determined by the identification module 2 or directly by the payment terminal 3, a receipt is issued and the payment is concluded.

If the check is negative, the input must be repeated.

If appropriate, at this juncture a signature by the user 1 on the receipt may be of further advantage.

The checkout data is collected and transferred for further processing at a later point in time.

FIG. 6 shows the sequence in the case of module Four, checklist code for e-banking.

In this case, together with the request 5, the user 1 issues details of the bank connection required, i.e. details of the bank concerned and the account concerned.

The process can be designed in such a way that the TRX represents the checklist code required.

After receipt of the TRX by means of SMS message, the user 1 can input, in a login mask on his PC connected to the Internet, as well as his user ID, the TRX and a PIN. This now gives him the opportunity of using the TRX as a checklist code.

If the input is correct, the e-banking application is started; otherwise, the sequence must be repeated.

In particular in the situation of the checklist code represented, but in other modules also, it may be advantageous if the TRX is shown on the display of the mobile telephone 11 but not in the mobile telephone, for example, in which the SIM card is stored. This means that later misuse by reading out the TRX from the mobile telephone 11 can be excluded.

FIG. 7 shows the sequence in the case of module Five, cash dispensing at an automatic cash dispenser.

In this case, together with the request 5 the identification number of the cash dispenser concerned is also sent.

After the TRX is received by means of SMS message, access to the cash dispenser is automatically opened. The user 1 then confirms the TRX which is standing ready by inputting an Applications PIN, for example directly at the keypad of the cash dispenser.

The desired denomination values can then be input.

If the input is correct, the desired amount of money will be paid out.

As a further security arrangement, provision may be made for a further PIN to be input directly at the keypad of the automatic cash dispenser.

FIG. 8 shows a further sequence in the case of module Number Six, e-ticket by remote transaction.

In this case, together with the request 5, the identification number of the corresponding payment terminal 3 is sent. The payment terminal 3 itself can be a stationary cash desk, but also a mobile payment terminal, such as a train ticket inspector.

On receipt of the TRX by means of SMS message, the user 1 now inputs the Applications PIN concerned at the payment terminal 3 of the ticket inspector as confirmation of the transaction. The input is again automatically checked, and, if the response is positive, a receipt and a ticket are printed out.

Otherwise, the process must be repeated.

FIG. 9 shows the further sequence in the case of module Number Seven, Access Control. After receipt of the TRX by means of SMS message, the user now enters in a login mask on his PC, connected to the Internet, in addition to his user ID, also the TRX and a PIN, for termination.

If the input is correct, the application concerned is started. Otherwise the process must be repeated.

With regard to module Number Eight, e-voting, details have already been provided above in the description of FIG. 2.

The advantages of the method according to the invention can be summarized as follows:
No security-relevant data relating to the user is passed to the other party involved in the action together with the user. The action can nevertheless be carried out under a particularly high level of security.
The security factor is decisively raised by a TRX that on the one hand is limited in time and, on the other, is valid only once (or only for a limited number of times).
The sequence of an action can be speeded up by the subdivision according to the invention of the procedure into “pre-authorization” and “termination”, since a payment action can already be initiated before the corresponding payment sum is present at a payment terminal.
A very large number of different types of terminal can be controlled according to the invention, since actuation takes place via an air interface.
When an election is being held, the locationally-independent and particularly flexible time arrangements possible for the casting of a vote mean that an increase in participation in an election or referendum is to be expected.
A modular structure allows for a highly user-friendly application of the method, whereby use is possible with a very widely differing range of action types.

### LIST OF REFERENCE NUMBERS

1 User of a mobile terminal/mobile telephone
2 Identification module
3 Terminal of the third party
5 Request for a TRX by the user
6 Generation of a TRX
7 Transmission of the TRX to the mobile terminal
8 Transmission of the TRX and a PIN to the identification module
8′ Transmission of the TRX and a PIN to the terminal of the third party
10 Pre-authorization
11 Mobile terminal/mobile telephone
20 Termination
50 Request by a TRX for download of voting documentation
60 Generation of a TRX for download of voting documentation
70 Transmission of the TRX for download of voting documentation to the mobile terminal
77 Transmission of the TRX to the terminal of the third party
80 Termination of the download part
500 Request for a TRX for casting a vote
600 Generation of a TRX for casting a vote
700 Sending the TRX for casting a vote to the mobile telephone
770 Sending the TRX for download to the terminal of the election authority
800 Termination of the vote casting part
7700 Sending the TRX for casting a vote to the terminal of the election authority

1. A method for the identification of a user and generation of an action authorization for the user, with the aid of a mobile terminal and an identification module, whereby the action is an access authorization or an electronic ticket, comprising the following steps:
a) selecting a desired action type by menu control on the mobile terminal,
b) transmitting the action authorization request together with an identification code from the mobile terminal to the identification module, whereby the action authorization request indicates the type of action and at least one parameter of the action authorization requested,
c) checking by the identification module as to whether the action authorization with the at least one parameter is permissible for the identification code, and, if it is permissible:
d) generating an action code for the action authorization requested by the identification module, whereby the action code records, in relation to at least one third location, a clearance for the action with the at least one parameter by the identification module,
e) transmitting the action code wirelessly from the identification module to the mobile terminal, and
f) displaying the action code on a display of the mobile terminal.

2. The method according to claim 1, characterized in that the method is terminated and the action authorization is issued, in that the user sends the action code via the Internet to a server, which functions as the terminal of an application operator.

3. The method according to claim 1, wherein the validity of the action code is time-limited and/or the maximum number of action authorizations for which the action code is valid is limited.

4. The method according to claim 1, wherein in step a), a personal identification number of the user is additionally sent by the mobile terminal to the identification module.

5. The method according to claim 1 wherein a communication that takes place between the mobile terminal and the identification module is at least partially encoded.

6. The method according to claim 1 wherein a communication between the mobile terminal and the identification module is carried out at least partially by means of a data channel.

7. The method according to claim 1 wherein in a communication between the mobile terminal and the identification module data is used which is read out from a data carrier in the mobile terminal.

8. The method according to claim 1 wherein in step a) a plausibility check is additionally carried out, by sending network information is sent to the identification module which relates to the network used for the transmission in step a).

9. The method according to claim 7, wherein a network information containing details relating to a provider, a radio cell, or combinations thereof is used in step a).

10. The method according to claim 1 wherein the action code is shown on the display of the mobile terminal.

11. The method according to claim 1 wherein information relating to the action to which step a) relates is deposited in a data carrier of the mobile terminal.

12. The method according to claim 10, wherein an information from the mobile terminal is read out, transferred to another device, or combinations thereof.

13. A method for the handling of a payment procedure between a user of a mobile terminal and a payment recipient, with the aid of the mobile terminal, an identification module, and a payment terminal of the payment recipient, comprising the following steps:
a) transmitting an authorization request for the payment procedure and an identification code from the mobile terminal to the identification module, whereby the authorization request indicates parameters of a payment authorization requested,
b) checking by the identification module as to whether a payment authorization for the identification code with at least one parameter is permissible, and, if it permissible:
c) generating a transaction code for the payment procedure requested by the identification module,
d) transmitting the transaction code from the identification module to the mobile terminal and to the payment terminal, whereby the transaction code displays in relation to the payment terminal (3) the fact that the identified user is entitled to carry out the payment procedure specified by the parameter.

14. A method for the handling of a payment procedure between a user of a mobile terminal and a payment recipient, with the aid of the mobile terminal, an identification module, and a payment terminal of the payment recipient, whereby the communication between the mobile terminal, the identification module and the payment terminal is carried out via an air interface, having a first phase comprising the following steps:
a1) transmitting an authorization request for the payment procedure, an identification code, and a maximum amount for a payment as a payment framework from the mobile terminal to the identification module,
a2) checking by the identification module as to whether an authorization for the identification code is permissible, and, if it is permissible:
a3) generating a transaction code for the payment procedure requested by the identification module,
a4) transmitting the transaction code from the identification module to the mobile terminal and to the payment terminal, and transmitting the payment framework from the identification module to the payment terminal, further comprises a phase following in time with the following step:
b1) concluding the payment procedure by the transmission or input of a code into the payment terminal, as a result of which the payment procedure is concluded.

15. A mobile terminal, programmed to carry out a method according to claim 1.

16. A software program capable of implementing the method of claim 1.

17. A mobile terminal, programmed to carry out a method according to claim 13.

18. A mobile terminal, programmed to carry out a method according to claim 14.

19. A software program capable of implementing the method of claim 13.

20. A software program capable of implementing the method of claim 14.
